(19) United States
(12) Patent Application Publication
(10) Pub. No.: US 2011/0114722 A1
(43) Pub. Date: May 19, 2011

(54) MIFARE CARD, MIFARE ACCESS APPARATUS, AND ACCESS METHOD THEREOF

(75) Inventor: Chih-Ta LIN, Taipei City (TW)

(73) Assignee: INSTITUTE FOR INFORMATION INDUSTRY, Taipei (TW)

(21) Appl. No.: 12/627,586

(22) Filed: Nov. 30, 2009

(30) Foreign Application Priority Data
Nov. 13, 2009 (TW) 098138580

(51) Int. Cl. G06K 5/00; G06K 19/06

(52) U.S. Cl. 235/382; 235/492

(57) ABSTRACT

A Mifare card, a Mifare access apparatus, and an access method thereof are provided. The Mifare card has an application index. The Mifare access apparatus may obtain the application index when the Mifare card approaches. The Mifare access apparatus may access the application data according to an application entry address of the application index which corresponds to the application data. Thereby, the application of Mifare card is becoming more flexible.

### PRIORITY

This application claims priority to Taiwan Patent Application No. 098138580 filed on Nov. 13, 2009, the disclosure of which is incorporated by reference herein in its entirety.

### FIELD

The present invention relates to an Mifare card, an Mifare access apparatus, and an access method thereof. Specifically, the present invention relates to an Mifare card, an Mifare access apparatus, and an access method thereof for accessing application data according to an application index.

### BACKGROUND

As the radio frequency identification (RFID) technology becomes matured, the application scope thereof is increasingly widened accordingly. The Mifare card access system is just one of its applications. For example, one of the Mifare card access systems that are the most commonly found in people's daily life is the Easy card system adopted by rapid transit companies. Hereinbelow, the operation mechanism of a conventional Mifare card access system will be described.

The Mifare card is an un-touchable intellectual card which may processes different applications in the single card. This technique, which installs the chip on the card and accesses data of the chip with an un-touching way, is especially adapted to apply in the public transportation payment system, such as the paying tool for tickets. The size of the Mifare card is similar to the normal credit card. When using this card to process a transaction data, the cardholder only needs to move the card close to the read/write machine, then the reading and changing for the data is accomplished.

In general, an Mifare card access system comprises an Mifare card and an Mifare card access apparatus. Taking the Easy card system as an example, it comprises Easy cards and Easy card access apparatuses respectively disposed at entrances and exits of rapid transit stations. When the Mifare card is approaching the Mifare card access apparatus, the instantaneous current will be generated, owing to a magnetic field effect, to drive the chip in the Mifare card. Thus, data exchange may be carried out between the Mifare card and the Mifare card access apparatus, for example, to deduct money from the Easy card. This kind of Mifare card is advantageous in that it may operate permanently without need of a battery.

However, the conventional Mifare card will no longer be able to be dynamically updated with new functions (e.g., to add an electronic purse function to the Easy card after the card is issued) through the Mifare card access apparatus, once it is issued. In other words, if it is desired to integrate a number of functions into the conventional Mifare card, all these functions must be integrated into the card before it is issued to a user for use. This mechanism makes the Mifare card inflexible in use, further decreasing the added value of the whole Mifare card access system.

Therefore, there remains a need in the art to allow for adding new functions to an Mifare card at any time according to practical needs after the Mifare card has been issued to a consumer, thereby making it more flexible in use.

### SUMMARY

An objective of certain embodiments of the present invention is to provide an Mifare access system, which comprises an Mifare access apparatus and an Mifare card. The Mifare card is configured to store an application index associated with a plurality of application data. The Mifare access apparatus is configured to emit a drive signal for driving the Mifare card, obtain the application index from the Mifare card after the Mifare card is driven, and perform a corresponding operation on any of the application data according to the application index.

To accomplish this objective, the Mifare card of certain embodiments of the present invention comprises a chip and a coil. The chip is electrically connected to the coil. The coil is configured to generate a drive current according to the drive signal, and the chip is configured to store the application index and enter an operation status to transmit the application index of the chip to the Mifare access apparatus according to the drive current.

Also to accomplish this objective, certain embodiments of the present invention further provide an access method for use in the aforesaid Mifare card. The access method in certain embodiments comprises the steps of: (a) enabling the coil to generate a drive current according to the signal; (b) enabling the chip to enter an operation status according to the drive current; and (c) enabling the chip to transmit the application index to the Mifare access apparatus after entering the operation status.

Further, to accomplish this objective in particular embodiments, the Mifare access apparatus comprises a microprocessor, an access interface and a sensor. The access interface is electrically connected to the microprocessor and the sensor. The sensor is configured to sense the Mifare card to generate the aforesaid drive signal, and transmit the drive signal via the access interface to drive the Mifare card. The microprocessor is configured to receive the application index of the Mifare card via the access interface after the Mifare is driven, and is further configured to generate a data request signal to the Mifare card according to the application index, so as to access one of the application data of the Mifare card.

Further, to accomplish this objective, certain embodiments of the present invention provide an access method for the aforesaid Mifare access apparatus. The access method according to certain embodiments comprises the following steps of: (a) enabling the sensor to sense the Mifare card to generate a drive signal; (b) enabling the sensor to transmit the drive signal via the access interface to drive the Mifare card; (c) enabling the microprocessor to receive the application index of the Mifare card via the access interface; and (d) enabling the microprocessor to generate a data request signal to the Mifare card according to the application index, so as to access one of the application data of the Mifare card.

According to the above description, the Mifare access apparatus of certain embodiments of the present invention is adapted to obtain an application index from the Mifare card after the Mifare card enters an operation status. Since the application index corresponds to each of the application data stored in the Mifare card, the Mifare access apparatus may access and perform an operation on the application data according to the application index. The Mifare access apparatus may further store a new application data into the Mifare card and, meanwhile, update the application index so that other Mifare access apparatuses may access and perform an operation on the new application data according to the updated application index in the Mifare card. In this way, by using the Mifare card and the Mifare access apparatus of the present invention in combination, the shortcoming of the conventional Mifare card access system that it lacks flexibility in use is overcome effectively, resulting in an increased added value of the whole Mifare access system.

The detailed technology and preferred embodiments implemented for the subject invention are described in the following paragraphs accompanying the appended drawings for people skilled in this field to well appreciate the features of the claimed invention. It is understood that the features mentioned hereinbefore and those to be commented on hereinafter may be used not only in the specified combinations, but also in other combinations or in isolation, without departing from the scope of the present invention.

### BRIEF DESCRIPTION OF THE DRAWINGS

FIG. 1 is a schematic view of an Mifare access system according to a first embodiment of the present invention;

FIG. 2 is a schematic view illustrating a memory structure of a chip in the first embodiment of the present invention; and

FIGS. 3A-3C illustrate a flowchart of an access method according to a second embodiment of the present invention.

While the invention is amenable to various modifications and alternative forms, specifics thereof have been shown by way of example in the drawings and will be described in detail. It should be understood, however, that the intention is not to limit the invention to the particular example embodiments described. On the contrary, the invention is to cover all modifications, equivalents, and alternatives falling within the spirit and scope of the invention as defined by the appended claims.

### DETAILED DESCRIPTION

In the following description, the present invention will be explained with reference to embodiments thereof. The present invention relates to an Mifare access system, which is implemented by an Mifare access apparatus and an Mifare card in combination. The Mifare access apparatus is adapted to access application data from the Mifare card according to an application index stored in the Mifare card, which may not only enhance convenience in use of the Mifare card, but also flexibly expand the application scope thereof. However, these embodiments are not intended to limit this invention to any specific environment, applications or particular implementations described in these embodiments. Therefore, description of these embodiments is only for purpose of illustration rather than to limit the present invention. It should be appreciated that, in the following embodiments and the attached drawings, elements unrelated to the present invention are omitted from depiction; and dimensional relationships among individual elements in the attached drawings are illustrated only for ease of understanding, but not to limit the actual scale.

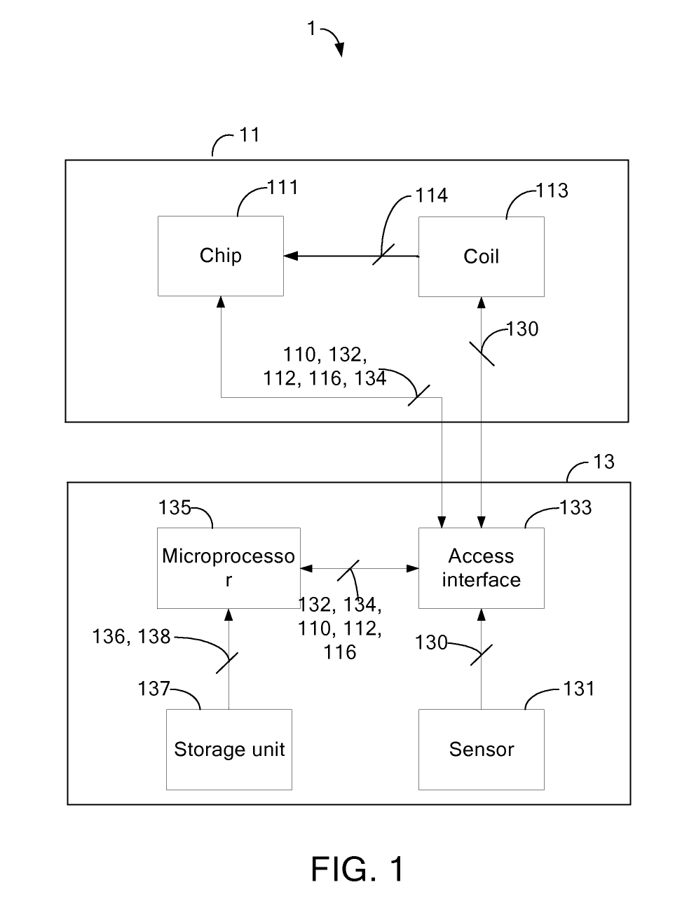

A first embodiment of the present invention is shown in FIG. 1, which is a schematic view of an Mifare access system 1. The Mifare access system 1 comprises an Mifare card 11 and an Mifare access apparatus 13. For example, the Mifare access system 1 may be viewed as an Easy card access system in which the Mifare card 11 is an Easy card and the Mifare access apparatus 13 is an Easy card access apparatus disposed at an entrance or exit of a rapid transit station. Hereinbelow, the structures of the Mifare card 11 and the Mifare access apparatus 13 as well as how they are used in combination will be described respectively.

As may be seen from FIG. 1, the Mifare card 11 comprises a chip 111 and a coil 113. The coil 113 is electrically connected to the chip 111. The chip 111 has a serial number 116 for purpose of identification and is configured to store an application index 110, a plurality of application data 112 corresponding to the application index 110, a first key group corresponding to the application index 110 and a second key group corresponding to the application data 112.

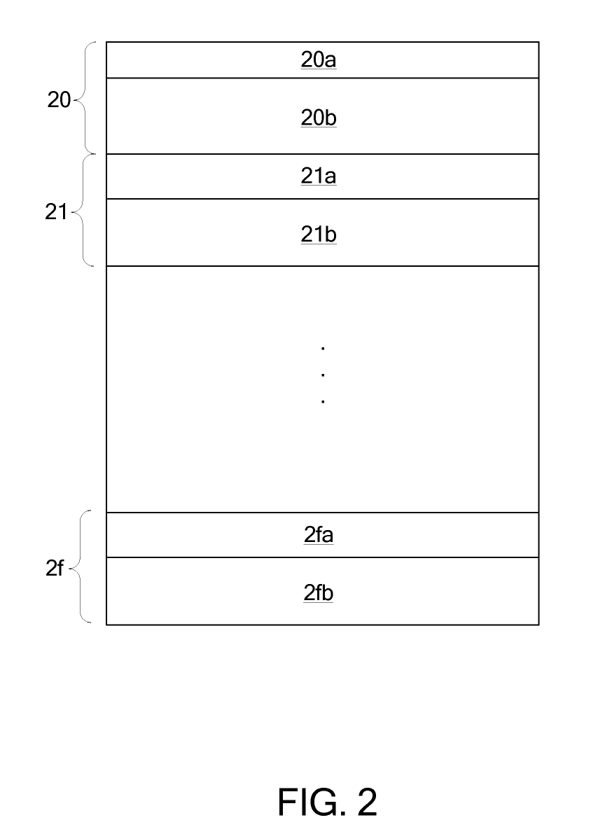

In more detail, referring to FIG. 2, a schematic view of a memory structure of the chip 111 is shown therein. For convenience of description, in this embodiment, the chip 111 is assumed to have a memory space of 1024×8 bytes, which is divided into sixteen storage sector s, namely, a first storage sector 20, a second storage sector 21, . . . , and a sixteenth storage sector 2f.

Taking the first storage sector 20 as an example, it at least comprises a protection block 20a and a data block 20b. The protection block 20a is configured to store the first key group for protecting the application index 110, and the data block 20b is configured to store the application index 110. The second storage sector 21 at least comprises a protection block 21a and a data block 21b. The protection block 21a is configured to store the second key group for protecting the application data 112, and the data block 21b is configured to store the application data 112. The protection block 2fa and the data block 2fb of the sixteenth storage sector 2f have the same functions as the protection block 21a and the data block 21b of the second storage sector 21 and, thus, will not be further described herein.

Further, it should be understood that, in other embodiments, the application index, the first key group of the application index and its access authority may be stored in any one or it's combination in the storage sector s 21-2f, upon its practical application needs. Accordingly, the application data, the second key group of the application data and its access authority also may be stored in other blank sectors, upon the practical application needs. Thus, it does not limit the scope of the present invention.

On the other hand, as also may be seen from FIG. 1, the Mifare access apparatus 13 comprises a sensor 131, an access interface 133, a microprocessor 135 and a storage unit 137. The access interface 133 is electrically connected to the sensor 131 and the microprocessor 135 respectively. The storage unit 137 is electrically connected to the microprocessor 135 and configured to store a first key group and a second key group. It should be noted that, the first key group and the second key group stored in the storage unit 137 of the Mifare access apparatus 13 are identical to those of the chip 111 of the Mifare card 11. Next, how the Mifare card 11 works with the Mifare access apparatus 13 will be described.

Referring back to FIG. 1, when the Mifare card 11 is approaching the Mifare access apparatus 13, this may be sensed by the sensor 131 of the Mifare access apparatus 13 to generate a drive signal 130. The drive signal 130 is sent via the access interface 133 to drive the Mifare card 11. The coil 113 of the Mifare card 11 is adapted to generate a drive current 114 according to the drive signal 130, and according to the drive current 114, the chip 111 of the Mifare card 11 enters an operation status to perform a pre-procedure with the Mifare access apparatus 13. Upon completion of the pre-procedure, the chip 111 transmits the serial number 116 to the Mifare access apparatus 13.

From the perspective of the Mifare access apparatus 13, the microprocessor 135 performs the aforesaid pre-procedure with the chip 111 of the Mifare card 11 via the access interface 133 to read the serial number 116. Thus, the Mifare access apparatus 13 may learn that it will interact with the Mifare card 11 having the serial number 116. It should be noted that, the aforesaid pre-procedure may be accomplished by a conventional technology and, thus, will not be further described herein.

Upon completion of the pre-procedure, the microprocessor 135 of the Mifare access apparatus 13 performs a 3-pass authentication procedure with the chip 111 of the Mifare card 11 according to the first key group 136 stored in the storage unit 137. On the other hand, the chip 111 of the Mifare card 11 also stores in the first storage sector 20a a key group that is identical to the first key group 136, so the chip 111 performs the aforesaid 3-pass authentication procedure with the microprocessor 135 of the Mifare access apparatus 13 according to the first key group stored in the first storage sector 20a to authenticate that the Mifare access apparatus 13 may legally access the application index 110 protected by the first key group. It should be appreciated that, the 3-pass authentication procedure adopted in this embodiment may be accomplished by a conventional technology and, thus, will not be further described herein.

Upon completion of the 3-pass authentication procedure, the chip 111 of the Mifare card 11 transmits the application index 110 stored in the first storage sector 20 to the Mifare access apparatus 13. After the application index 110 is transmitted, the microprocessor 135 of the Mifare access apparatus 13 receives the application index 110 via the access interface 133 according to the serial number 116, and generates a data request signal 132 to the Mifare card 11 according to the application index 110, so as to access the application data 112 of the Mifare card 11.

In more detail, the application index 110 records application entry addresses of the storage sector s 20-2f of the chip 111. For convenience of the following description, it is assumed herein that the application data 112 stored in the storage sector 21 is related to an electronic purse application. For instance, if it is desired to deduct money from the electronic purse, the Mifare access apparatus 13 may learn from the application index 110 an application entry address of the storage sector 21 where the application data 112 related to the electronic purse is stored.

After learning the application entry address of the storage sector 21, the microprocessor 135 of the Mifare access apparatus 13 performs the aforesaid 3-pass authentication procedure with the chip 111 of the Mifare card 11 according to the second key group 138 of the storage unit 137 so that the chip 111 of the Mifare card 11 may authenticate that the Mifare access apparatus 13 may legally access the application data 112 protected by the second key group of the chip 111.

Upon completion of the aforesaid 3-pass authentication procedure, the microprocessor 135 of the Mifare access apparatus 13 generates the data request signal 132 to the chip 111 of the Mifare card 11 according to the application entry address of the second storage sector 21 incorporated in the application index 110. Upon receiving the data request signal 132, the chip 111 of the Mifare card 11 retrieves the application data 112 from the second storage sector 21 according to the application entry address of the second storage sector 21 incorporated in the data request signal 132, and transmits the application data 112 to the Mifare access apparatus 13 for processing by the Mifare access apparatus 13 (e.g., to deduct money from the electronic purse). After the money is deducted, the Mifare access apparatus 13 may also write the result back to the second storage sector 21 of the chip 111 of the Mifare card 11.

Furthermore, if it is desired to add a new application data (e.g., a credit card application) to the aforesaid Mifare card 11. The aforesaid Mifare card may transmits the application index 110, which stored in the first storage sector 20, to the Mifare access apparatus 13. After the microprocessor 135 of the Mifare access apparatus 13 calculate the blank application storage sector address according to the application index 110. The microprocessor 135 of the Mifare access apparatus 13 may further transmit a new application data 134 to the Mifare card 11 via the access interface 133 for storing into a blank storage sector (e g, the storage sector 2f) of the chip. Next, the microprocessor 135 of the Mifare access apparatus 13 updates the application index 110 to generate an updated application index according to the application entry address of the storage sector 2f (i.e., a storage address of the new application data 134). Further, the microprocessor 135 of the Mifare apparatus 13 via the access interface 133 transmit and store the updated application index in the chip 111 of the Mifare card 11. So the Mifare access apparatus 13 may perform a further operation on the new application data 134 stored in the Mifare card 11 according to the updated application index.

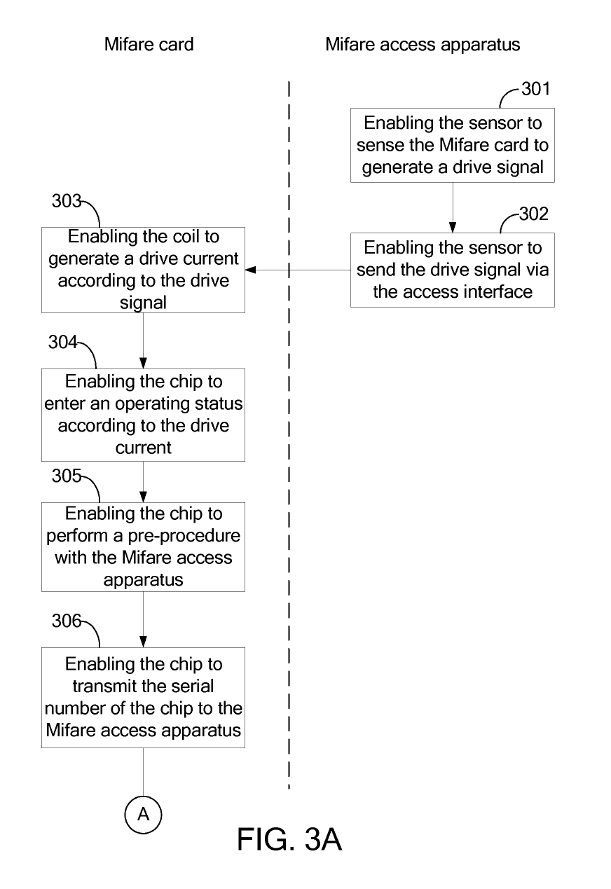

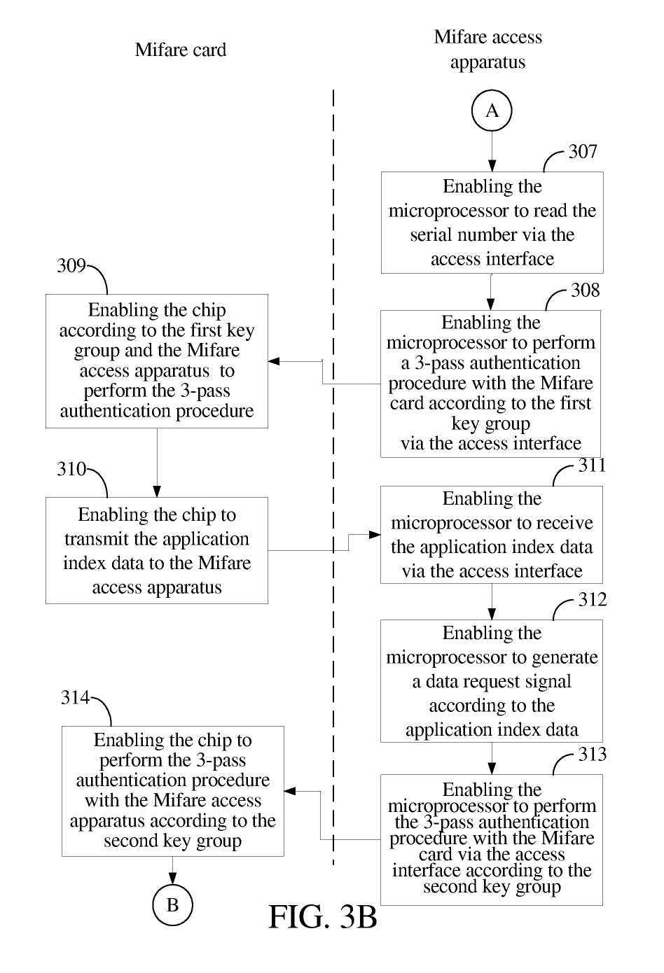

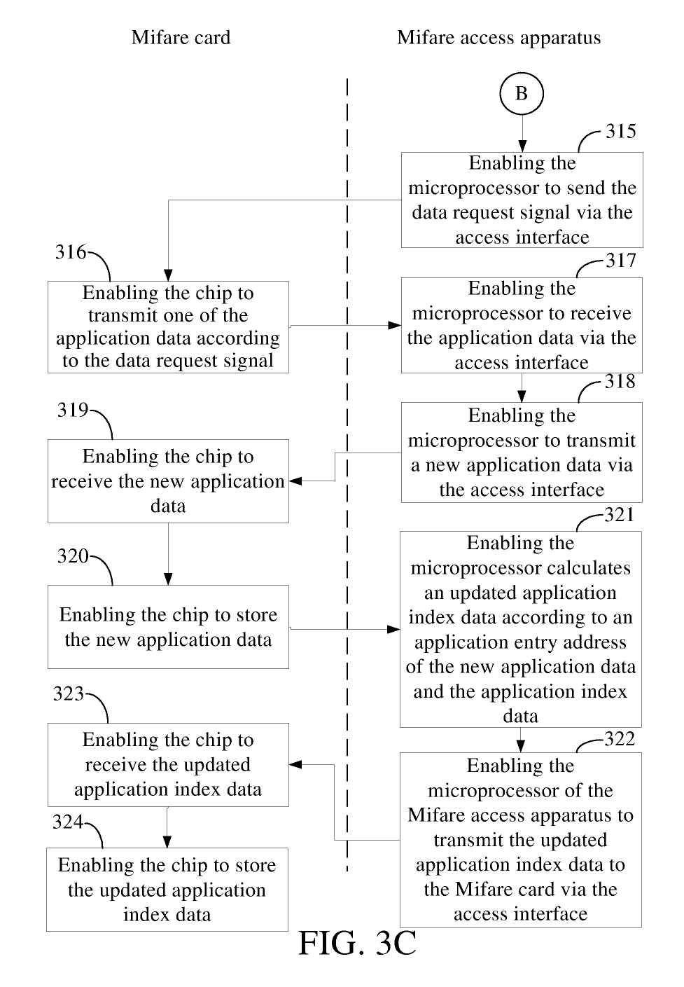

A second embodiment of the present invention is as shown in FIGS. 3A-3C, which illustrates a flowchart of an access method for use in an Mifare access system as described in the first embodiment. The Mifare access system comprises an Mifare card and an Mifare access apparatus. The Mifare card comprises a chip and a coil electrically connected to the chip. The chip has a serial number for purpose of identification and is configured to store an application index, a plurality of application data corresponding to the application index, a first key group and a second key group.

The Mifare access apparatus comprises a storage unit, a microprocessor, an access interface and a sensor. The access interface is electrically connected to the microprocessor and the sensor respectively. The storage unit is electrically connected to the microprocessor and configured to store a first key group and a second key group. It should be noted that, the first key group and the second key group stored in the storage unit of the Mifare access apparatus are identical to those of the chip of the Mifare card.

In more detail, a memory structure of the chip may be as shown in FIG. 2. In this embodiment, the chip is assumed to have a memory space of 1024×8 bytes, which is divided into sixteen storage sector s, namely, a first storage sector 20, a second storage sector 21, . . . , and a sixteenth storage sector 2f.

Taking the first storage sector 20 as an example, it at least comprises a protection block 20a and a data block 20b. The protection block 20a is configured to store the first key group and its access authority for protecting the application index, and the data block 20b is configured to store the application index. The second storage sector 21 at least comprises a protection block 21a and a data block 21b. The protection block 21a is configured to store the second key group and its access authority for protecting the application data, and the data block 21b is configured to store the application data. A protection block 2fa and a data block 2fb of the sixteenth storage sector 2f have the same functions as the protection block 21a and the data block 21b of the second storage sector 21 and, thus, will not be further described herein. Hereinbelow, a process flow of the access method according to this embodiment will be described.

Referring firstly to FIG. 3A, step 301 is executed to enable the sensor to sense the Mifare card to generate a drive signal. Then step 302 is executed to enable the sensor to transmit the drive signal via the access interface to drive the Mifare card. Next, step 303 is executed to enable the coil to generate a drive current according to the drive signal, and step 304 is executed to enable the chip to enter an operation status according to the drive current. Afterwards, step 305 is executed to enable the chip to perform a pre-procedure with the Mifare access apparatus, and step 306 is executed to enable the chip to transmit the serial number of the chip to the Mifare access apparatus so that the Mifare access apparatus receives the application index of the chip according to the serial number. It should be noted that, the pre-procedure may be accomplished by a conventional technology and, thus, will not be further described herein.

Referring next to FIG. 3B, step 307 is executed to enable the microprocessor to read the serial number of the Mifare card via the access interface, and step 308 is executed to enable the microprocessor to perform the aforesaid 3-pass authentication procedure with the Mifare card according to the first key group via the access interface, so as to access the application index of the first storage sector. And step 309 is executed to enable the chip according to the first key group and the Mifare access apparatus to perform the aforesaid 3-authentication procedure, so as to authenticate that the Mifare access apparatus may legally access the application index protected by the first key group. It should be appreciated that, the 3-pass authentication procedure adopted in this embodiment may be accomplished by a conventional technology, and will not be further described herein. Thereafter, step 310 is executed to enable the chip to transmit the application index of the first storage sector 20 to the Mifare access apparatus, and step 311 is executed to enable the microprocessor to receive the application index of the Mifare card via the access interface.

Next, step 312 is executed to enable the microprocessor to generate a data request signal to the Mifare card according to the application index, so as to access one of the application data of the Mifare card. In more detail, the application index records application entry addresses of the storage sector s 20-2f of the chip. For convenience of the following description, it is assumed herein that the application data stored in the storage sector 21 is related to an electronic purse application. For instance, if it is desired to deduct money from the electronic purse, the Mifare access apparatus may learn from the application index to know that an application entry address of the storage sector 21 where the application data related to the electronic purse is stored.

After the application entry address of the storage sector 21 is learned, step 313 is executed to enable the microprocessor to perform the 3-pass authentication procedure with the Mifare card via the access interface according to the second key group, and step 314 is executed to enable the chip to perform the 3-pass authentication procedure with the Mifare access apparatus according to the second key group so that the chip of the Mifare card may authenticate that the Mifare access apparatus may legally access the application data protected by the second key group of the chip.

Referring next to FIG. 3C, upon completion of the aforesaid 3-pass authentication procedure, step 315 is executed to enable the microprocessor to transmit the data request signal to the Mifare card via the access interface. The data request signal comprises an application entry address of the second storage sector 21. Then step 316 is executed to enable the chip to transmit one of the application data of the chip to the Mifare access apparatus according to the data request signal, and step 317 is executed to enable the microprocessor to receive the application data via the access interface.

In more detail, the chip of the Mifare card is adapted to retrieve the application data from the second storage sector 21 according to the application entry address of the second storage sector 21 incorporated in the data request signal, and transmits the application data to the Mifare access apparatus for processing by the Mifare access apparatus (e.g., to deduct money from the electronic purse). After the money is deducted, the Mifare access apparatus may also write the result back to the second storage sector 21 of the chip of the Mifare card.

Furthermore, if it is desired to add a new application data (e.g., a credit card application) to the Mifare card, step 318 is executed to enable the microprocessor to transmit a new application data to the Mifare card via the access interface so that the new application data is stored in the Mifare card. Next, step 319 is executed to enable the chip to receive the new application data, and step 320 is executed to enable the chip to store the new application data. Next, step 321 is executed to enable the microprocessor of the Mifare access apparatus calculates an update application index according to an application entry address of the new application data and the application index, and step 322 is executed to enable the microprocessor of the Mifare access apparatus transmits the update application index to the Mifare card via the access interface. Next, step 323 is executed to enable the chip to receive the update application index. Finally, step 324 is executed to enable the chip to store the update application index.

In more detail, in steps 320 to 323, the chip of the Mifare card stores the new application data into a blank storage sector of the chip (e.g., the storage sector 2f) and, according to an application entry address of the storage sector 2f (i.e., the storage address of the new application data), updates the application index to generate an updated application index so that the Mifare access apparatus may perform a further operation on the new application data stored in the Mifare card according to the updated application index.

In addition to the aforesaid steps, the second embodiment may also execute all the operations and functions set forth in the first embodiment. How the second embodiment executes these operations and functions will be readily appreciated by those of ordinary skill in the art based on the explanation of the first embodiment, and thus will not be further described herein.

According to the above description, the Mifare access apparatus according to certain embodiments of the present invention is adapted to obtain an application index from the Mifare card after the Mifare card enters an operation status. Since the application index datum corresponds to each of the application data stored in the Mifare card, the Mifare access apparatus may access and perform an operation on the application data according to the application index. In particular embodiments, the Mifare access apparatus may further store a new application data into the Mifare card and, meanwhile, update the application index so that other Mifare access apparatuses may access and perform an operation on (e.g., perform subsequent operations thereon, such as reading, writing, decrementing, incrementing, restoring and ceasing) the new application data according to the updated application index in the Mifare card. In this way, by using the Mifare card and the Mifare access apparatus of the present invention in combination, the shortcoming of the conventional Mifare card access system that it lacks flexibility in use is addressed, resulting in an increased added value of the whole Mifare access system.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. An Mifare card adapted for working with an Mifare access apparatus, the Mifare access apparatus being configured to emit a drive signal, the Mifare card comprising:
a chip, being configured to store an application index; and
a coil, being electrically connected to the chip and configured to generate a drive current according to the drive signal;
wherein, according to the drive current, the chip enters an operation status to transmit the application index of the chip to the Mifare access apparatus.

2. The Mifare card of claim 1, wherein the Mifare access apparatus is adapted to generate a data request signal according to the application index, and the chip is further configured to store a plurality of application data corresponding to the application index and transmit one of the application data of the chip to the Mifare access apparatus according to the data request signal.

3. The Mifare card of claim 2, wherein the chip further comprises a first storage sector for storing the application index and a first key group, the chip is adapted to perform a 3-pass authentication procedure with the Mifare access apparatus according to the first key group, and upon completion of the 3-pass authentication procedure, the chip transmits the application index to the Mifare access apparatus.

4. The Mifare card of claim 3, wherein the chip further comprises a second storage sector configured to store one of the application data and a second key group, the application index records an application entry address of the second storage sector, the chip is adapted to perform the 3-pass authentication procedure with the Mifare access apparatus according to the second key group, and upon completion of the 3-pass authentication procedure performed according to the second key group, the chip is adapted to transmit the application data of the second storage sector to the Mifare access apparatus according to the data request signal comprising the application entry address.

5. The Mifare card of claim 1, wherein the chip has a serial number, the chip is adapted to perform a pre-procedure with the Mifare access apparatus to transmit the serial number of the chip to the Mifare access apparatus after being driven so that the Mifare access apparatus receives the application index of the chip according to the serial number.

6. The Mifare card of claim 1, wherein the Mifare access apparatus is further adapted to transmit a new application data and an updated application index, the chip is further configured to store the new application data and the updated application index to update the application index to the updated application index.

7. An access method for use in an Mifare card, the Mifare card being adapted for working with an Mifare access apparatus, the Mifare access apparatus is configured to emit a drive signal, the Mifare card comprising a chip and a coil, the chip being electrically connected to the coil and storing an application index, the access method comprising the steps of:
(a) enabling the coil to generate a drive current according to the drive signal;
(b) enabling the chip to enter an operation status according to the drive current; and
(c) enabling the chip to transmit the application index to the Mifare access apparatus after entering the operation status.

8. The access method of claim 7, wherein the chip is further configured to store a plurality of application data corresponding to the application index, the Mifare access apparatus is adapted to generate a data request signal according to the application index, the access method further comprising the step of:
(d) enabling the chip to transmit one of the application data of the chip to the Mifare access apparatus according to the data request signal after the step (c).

9. The access method of claim 8, wherein the chip further comprises a first storage sector configured to store the application index and a first key group, the access method further comprising the step of:
enabling the chip to perform a 3-pass authentication procedure with the Mifare access apparatus according to the first key group before the step (c).

10. The access method of claim 9, wherein the chip further comprises a second storage sector for storing a second key group, the access method further comprising the step of:
enabling the chip to perform the 3-pass authentication procedure with the Mifare access apparatus according to the second key group.

11. The access method of claim 10, wherein the second storage sector is configured to store one of the application data, the application index records an application entry address of the second storage sector, and the step (d) is a step of enabling the chip to transmit the application data of the second storage sector to the Mifare access apparatus according to the data request signal comprising the application entry address.

12. The access method of claim 10, wherein the chip has a serial number, the access method further comprising the steps of:
after the step (b), enabling the chip to perform a pre-procedure with the Mifare access apparatus; and
enabling the chip to transmit the serial number of the chip to the Mifare access apparatus so that the Mifare access apparatus receives the application index of the chip according to the serial number.

13. The access method of claim 7, wherein the Mifare access apparatus is further adapted to transmit a new application data and an updated application index, the access method further comprising the steps of:
enabling the chip to store the new application data; and
enabling the chip to store the updated application index to update the application index to the updated application index.

14. An Mifare access apparatus for working with an Mifare card, the Mifare card storing an application index and a plurality of application data corresponding to the application index, the Mifare access apparatus comprising:
a microprocessor;
an access interface, being electrically connected to the microprocessor; and
a sensor, being electrically connected to the access interface, and being configured to sense the Mifare card to generate a drive signal and transmit the drive signal via the access interface to drive the Mifare card;
wherein, after the Mifare card is driven, the microprocessor is configured to receive the application index of the Mifare card via the access interface, and is further configured to generate a data request signal to the Mifare card according to the application index, so as to access one of the application data of the Mifare card.

15. The Mifare access apparatus of claim 14, wherein the Mifare card comprises a first storage sector for storing the application index, the Mifare access apparatus further comprises a storage unit electrically connected to the microprocessor and is configured to store a first key group, and the microprocessor is further configured to perform a 3-pass authentication procedure with the Mifare card via the access interface according to the first key group, so as to access the application index of the first storage sector.

16. The Mifare access apparatus of claim 15, wherein the Mifare card further comprises a second storage sector for storing one of the application data, the application index records an application entry address of the second storage sector, the storage unit is further configured to store a second key group, the microprocessor is configured to perform the 3-pass authentication procedure with the Mifare card via the access interface according to the second key group, and upon completion of the 3-pass authentication procedure, generate the data request signal to the Mifare card according to the application entry address of the application index, so as to access the application data of the second storage sector.

17. The Mifare access apparatus of claim 14, wherein the Mifare card has a serial number, the microprocessor is further configured to perform a pre-procedure with the Mifare card via the access interface to read the serial number of the Mifare card after the Mifare card is driven and configured to receive the application index of the Mifare card via the access interface according to the serial number.

18. The Mifare access apparatus of claim 14, wherein the microprocessor is further configured to transmit a new application data to the Mifare card, to generate an updated application index according to an application entry address of the new application data and the application index, and to transmit the updated application index to the Mifare card via the access interface so that the Mifare card stores the new application data and the updated application index.

19. An access method for use in an Mifare access apparatus, the Mifare access apparatus being adapted for working with an Mifare card, the Mifare card storing an application index and a plurality of application data corresponding to the application index, the Mifare access apparatus comprising a microprocessor, an access interface and a sensor, the access interface being electrically connected to the microprocessor and the sensor respectively, the access method comprising the steps of:
(a) enabling the sensor to sense the Mifare card to generate a drive signal;
(b) enabling the sensor to transmit the drive signal via the access interface to drive the Mifare card;
(c) enabling the microprocessor to receive the application index of the Mifare card via the access interface; and
(d) enabling the microprocessor to generate a data request signal to the Mifare card according to the application index, so as to access one of the application data of the Mifare card.

20. The access method of claim 19, wherein the Mifare card comprises a first storage sector for storing the application index, the Mifare access apparatus further comprises a storage unit electrically connected to the microprocessor and is configured to store a first key group, the access method further comprising the step of:
enabling the microprocessor to perform a 3-pass authentication procedure with the Mifare card via the access interface according to the first key group, so as to access the application index of the first storage sector.

21. The access method of claim 20, wherein the storage unit is further configured to store a second key group, the access method further comprising the step of:
enabling the microprocessor to perform the 3-pass authentication procedure with the Mifare card via the access interface according to the second key group.

22. The access method of claim 21, wherein the Mifare card further comprises a second storage sector for storing one of the application data, the application index records an application entry address of the second storage sector, the step (d) is a step of enabling the microprocessor to generate the data request signal to the Mifare card according to the application entry address of the application index, so as to access the application data of the second storage sector.

23. The access method of claim 19, wherein the Mifare card has a serial number, the access method further comprises the steps of:
enabling the microprocessor to perform a pre-procedure with the Mifare card via the access interface after the Mifare card is driven;
enabling the microprocessor to read the serial number of the Mifare card via the access interface; and
enabling the microprocessor to receive the application index of the Mifare card via the access interface according to the serial number.

24. The access method of claim 19, further comprising the steps of:
enabling the microprocessor to transmit a new application data to the Mifare card via the access interface;
enabling the microprocessor to generate an updated application index according to a application entry address of the new application data and the application index; and
enabling the microprocessor to transmit the updated application index to the Mifare card via the access interface so that the Mifare card stores the new application data and the updated application index.
